(19) United States
(12) Patent Application Publication
(10) Pub. No.: US 2004/0000408 A1
(43) Pub. Date: Jan. 1, 2004

(54) Ground heat fire-abatement sprinkler system

(76) Inventors: Robert Mancini, Toronto (CA); Gino DiRezze, Richmond Hill (CA); William John Welch, Erie, PA (US)

Correspondence Address: RICHARD K THOMSON, ATTORNEY, 7691 FAIRLANE DRIVE, FAIRVIEW, PA, 16415

(21) Appl. No.: 10/183,106

(22) Filed: Jun. 26, 2002

(51) Int. Cl. A62C 35/00

(52) U.S. Cl. 169/13; 169/16

(57) ABSTRACT

A fire-abatement sprinkler system is made economically more attractive by inclusion of a ground-loop heat exchanger. When a fire-abatement condition is not present, a pump circulates fluid through the ground heat exchanger, a portion of the supply and feed pipes of the sprinkler system, and at least one heat pump to permit energy to be transferred from/to the ground to/from the building housing the sprinkler system in order to alter the temperature therein and afford a payback of the installation costs.

### BACKGROUND AND SUMMARY OF THE INVENTION

The present invention is directed to a fire-abatement sprinkler system. More particularly, the present invention is directed to a sprinkler system that includes a ground heat exchange loop and a heat pump to provide a potential payback for installation of life-saving fire-abatement equipment.

A recent study has demonstrated that, nationwide, fire related deaths in commercial buildings has dropped over the last 20 years as fire-abatement sprinkler systems have been installed in an increasing number of commercial residential establishments. The study, undertaken by a joint committee of a State legislature, was conducted to determine the feasibility of retrofitting high-rise buildings, dormitories, fraternities/sororities, and public housing and health care facilities with fire-abatement sprinkler systems. The report concluded that the retrofitting was feasible and not “unduly costly” for those affected by possible legislation.

This legislation, when enacted nationally or in this and other states, could obviously have ramifications for universities, fraternities and sororities, in particular, which may not have a spare $100,000-$200,000 available for installation for such a system. Of course, the organization wants to comply with safety requirements imposed by its state in order to protect its residents/members. However, some houses or dorms may be faced with closing given the level of expense involved.

It is an object of the present invention to provide a positive incentive for installation of fire-abatement sprinkler systems(in addition to the incentive of avoidance of the negative aspects of inadequate fire safety) by offering the prospect of a financial payback. The present invention consists of, in a fire-abatement sprinkler system for use in a building, where the system includes a supply line for feeding fluid to a plurality of sprinkler heads suspended from a ceiling of the building, the supply line including a connection to a water line through an alarm-activating check valve, and a secondary supply connection including a Siamese connection for fire fighters to access, the improvement comprising a circulation loop connected to the supply line said circulation loop including a) at least one circulation pump for circulating fluid through said circulation loop; b) a subterranean ground exchange heat loop; c) at least one heat pump in said circulation loop to extract heat energy from the circulating fluid and use the heat energy to modify a temperature within the building; whereby an installer of a fire-abatement sprinkler system can be provided a payback.

Various other features, advantages and characteristics of the present invention will become apparent after a reading of the following detailed description.

### BRIEF DESCRIPTION OF THE DRAWINGS

The preferred embodiment(s) of the present invention are set forth in the drawings, like items bearing like reference numerals and in which

FIG. 1 is a schematic flow diagram of a first embodiment of the improved fire-abatement sprinkler system of the present invention.

### DETAILED DESCRIPTION OF THE PREFERRED EMBODIMENT(S)

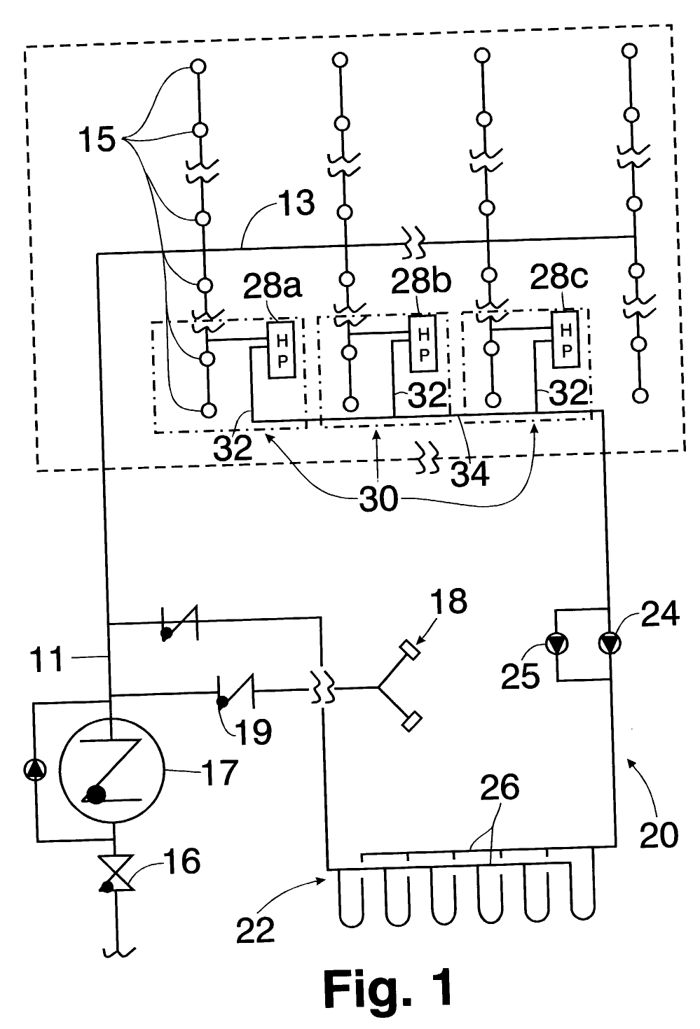

A first preferred embodiment of the ground heat fire-abatement sprinkler system of the present invention is shown in FIG. 1 generally at 20. A conventional fire-abatement sprinkler system includes a supply line 11, a feed line 13 which is suspended by a ceiling (not shown) and typically is contained in the ceiling, the feed line 13 supplying fluid, typically water, to a plurality of sprinkler heads 15. Supply line 11 connects to water main 16 through an alarm-activating check valve 17. A secondary supply connection is provided through a Siamese connection 18 connected to the supply line 11 through a backflow preventing valve 19 to permit firemen to connect to the sprinkler system and increase the pressure/water flow to sprinkler heads 15 to enhance fire abatement.

The improvement of the present invention comprises equipping this conventional system with a ground heat circulation loop 22. Circulation loop 22 includes at least a first circulating pump 24 for circulating fluid and, preferably, a second circulating pump 25 connected in parallel to first pump 24 to provide backup redundancy for the system should the first 24 pump fail; a subterranean ground heat exchanger 26 for extracting heat energy from/transferring heat energy to the ground; and, at least one heat pump 28a for removing/transmitting heat energy from/to the circulated fluid. More preferably, there is a first plurality heat pumps 28a, 28b, 28c and a second plurality of circulating sub-loops 30, each sub-loop including at least a portion of feed line 13 and a connection 32 to a return line 34 which closes the loop to circulating pump 24 returning fluid thereto in normal (non-fire-abatement) operation for re-feeding through the ground heat exchanger 26. Just as heat pump can obtain energy from external air in winter, so the ground heat exchange loop 22 of the present invention can permit energy to be exchanged with the ground and transmitted to the room(s) in which the sprinklers are positioned, whether heating or cooling the room(s). The ground heat exchanger 26 typically has a piping system formed in a serpentine pattern made of plastic such as high-density polyethylene. At a depth of six feet, the earth typically maintains an average temperature in the range between 45 and 70° allowing the earth to provide a heat source in the winter and serve as a heat sink in the summer. While a serpentine surface configuration has been shown, it will be appreciated that the system can be reconfigured to fit the available space from 6 to 600 feet and can also work with straight pipe sections. The promise of a reduction in the HVAC expense of a building can provide an organization an incentive for installing a sprinkler system or modifying an existing system, since the possibility of a payback exists. Further, local, state or federal funding may be available to help offset installation expenses as result of reduced use of expendable resources, such as fossil fuels.

Various changes, alternatives and modifications will become apparent to a person of ordinary skill in the art following a reading of the foregoing specification. It is intended that all such changes, alternatives and modifications as fall within the scope of the appended claims be considered part of this invention.

I claim:

1. In a fire-abatement sprinkler system for use in a building, the system including a supply line, a feed line suspended by a ceiling of a building for feeding fluid to a plurality of sprinkler heads, the supply line including a connection to a water line through an alarm-activating check valve, and a secondary supply connection including a Siamese connection for fire fighters to access, the improvement comprising a ground heat circulation loop connected to the supply line said ground heat circulation loop including
a) at least one circulation pump for circulating fluid through said circulation loop;
b) a subterranean ground exchange heat loop;
c) at least one heat pump in said circulation loop to transfer heat energy from/to the circulating fluid thereby using the heat energy to modify a temperature within the building; whereby an installer of a fire-abatement sprinkler system can be provided a payback.

2. The improvement of claim 1 wherein said at least one circulating pump comprises a first circulating pump and at least one backup circulating pump in parallel to said first circulating pump to provide said fire-abatement sprinkler system with built in redundancy.

3. The improvement of claim 1 further comprising a first plurality of heat pumps, one in each of a second plurality of circulating sub-loops, each of said second plurality of circulating sub-loops including a) a portion of the feed line, b) a heat pump, and c) a connection to a return line carrying fluid back to said at least one circulating pump.
